(19) United States
(12) Patent Application Publication
(10) Pub. No.: US 2020/0130927 A1
(43) Pub. Date: Apr. 30, 2020

(54) FREIGHT CONTAINER WITH FIRE SUPPRESSION

(71) Applicant: Nordisk Aviation Products AS, Holmestrand (NO)

(72) Inventors: Mats Frydenlund Evensen, Sandefjord (NO); Christian Arnesen, Holmestrand (NO)

(21) Appl. No.: 16/176,043

(22) Filed: Oct. 31, 2018

(51) Int. Cl. B65D 90/22; A62C 2/20; A62C 3/00; A62C 2/06; A62C 3/08; B65D 88/12; B65D 88/14; B65D 90/00; B65D 90/58

(52) U.S. Cl. CPC B65D 90/22; A62C 2/20; A62C 3/002; A62C 3/14; A62C 3/08; B65D 2590/664; B65D 88/14; B65D 90/008; B65D 90/587; B65D 2590/542; B65D 88/127

(57) ABSTRACT

A freight container (1) has a frame to which a bottom (2), a roof (3), and sides (5-7) are attached, one side having a door opening closeable by a folding door (12) made of flexible, fire resistant material. The door (12) is supported from runners (13) moveable along a rail (14) combined with a top member (9) of a frame delimiting the door opening. A gap (15) is formed between the top frame member (9) and the top of the door (12) in its closed condition. The top member (9) is provided with a depending support (16) having a surface facing the inside of the door (12) and having attached thereto a strip of heat intumescent material (20). A flow passage (18) is formed between the strip (20) and the door (12) for gasses attempting to escape from the container through the gap (15) in a fire inside the container. The heat intumescent material (20) is arranged to swell and close the flow passage (18) when subjected to hot gasses from the fire inside the container.

### FIELD OF THE INVENTION

The invention relates to a freight container, more specifically an air freight container with means for suppressing a fire caused therein by a cargo element.

### BACKGROUND OF THE INVENTION

There has been a rising concern over the possibility of lithium batteries to short circuit, self-ignite and cause fires, particularly as regards batteries of inferior quality. Since such batteries are extensively used in personal electronic devices, spare batteries are often bought via the Internet from suppliers in East Asia and shipped in air freight containers as parcel post or mail to destinations all over the world.

A fire started by a battery is most often difficult to control by conventional means, i.a. since the source will normally be buried in a stack of goods. Recent efforts have therefore concentrated on choking the fire or at least substantially reducing its intensity, while keeping it inside the container long enough for the aircraft to make a safe landing, preferably for at least six hours.

The choking effect is attempted by tightly sealing the perimeter of the flexible door normally found in such containers. A problem will occur in containers having a folding door suspended from hangers, movable in a rail at the top of the door opening, leaving a ventilation gap between the top of the door and the rail. Besides permitting ventilation of the container, this gap also allows equalization of the air pressure in the container as the aircraft air pressure fluctuates. The gap is therefore essential in normal operation of the container.

### BRIEF SUMMARY OF THE INVENTION

An object of the invention is to alleviate the problems of folding door containers in an internal fire situation. According to a first embodiment of the invention, a passage is formed between the inside of the door and a support depending from an upper frame member to below the gap, thus forcing gas from inside the container to pass through the passage before exiting through the gap, wherein a heat swellable material is arranged in the passage and is intended to swell and close the passage when subjected to hot gasses from a fire in the container.

A freight container has a frame to which a bottom, a roof, and sides are attached, one side having a door opening closeable by a folding door made of flexible, fire resistant material. The door is supported from runners moveable along a rail combined with a top member of a frame delimiting the door opening. A gap is formed between the top frame member and the top of the door in its closed condition. The top member is provided with a depending support having a surface facing the inside of the door and having attached thereto a strip of heat intumescent material. A flow passage is formed between the strip and the door for gasses attempting to escape from the container through the gap in a fire inside the container. The heat intumescent material is arranged to swell and close the flow passage when subjected to hot gasses from the fire inside the container.

The invention is defined in independent claims, and useful features are defined in dependent claims.

Further objects of the invention are to provide a method and an element employed in the method for improving the ability to suppress fires inside the container. These objects are met as defined in respective independent claims.

### DESCRIPTION OF THE SEVERAL VIEWS OF THE DRAWINGS

An exemplifying embodiment of the invention is illustrated in the appended schematic drawings, in which:

FIG. 1 is a perspective view of an air freight container;

FIG. 2 is a front view of the container in FIG. 1;

FIG. 3 is a sectional view of a plane through the line A-A in FIG. 2 in a normal operating condition of the container; and

FIG. 4 is a sectional view like FIG. 3 in a fire condition of the container.

### DETAILED DESCRIPTION OF THE INVENTION

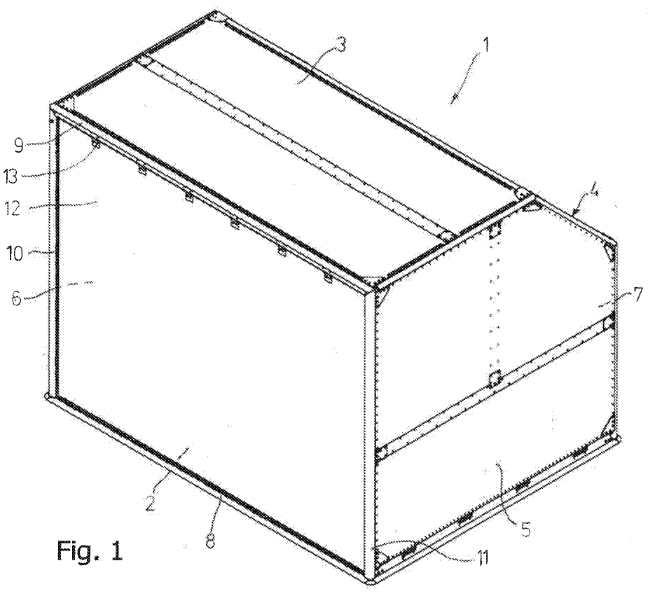

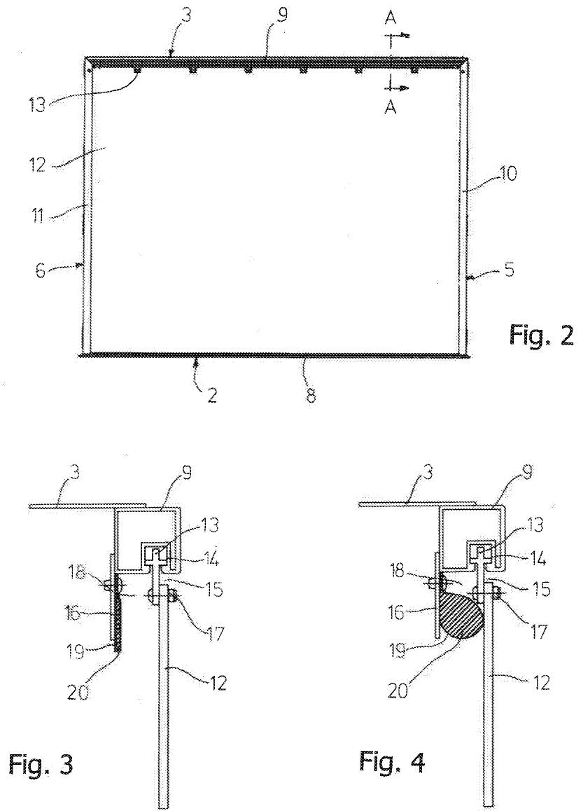

The exemplifying container 1 illustrated in FIGS. 1-4 is an air freight container classified according to the International Air Transport Association (IATA) rules as an AMJ air cargo container. As shown in FIG. 1, the container has a generally prismatic form and comprises a bottom panel 2, two roof panels 3, 4, opposing side panels 5, 6, and a rear side panel 7. As best seen from FIG. 2, these panels are attached to a framework, of which a front opening of the container is delimited by a bottom frame member 8, a top or roof frame member 9, and two opposed vertical frame members 10, 11 connecting the bottom and top frame members.

The front opening is closed by a folding door 12 comprising a fire resistant, flexible fabric, as will be well known to the skilled person and should need no further identification here. Normally, a reinforcing net is arranged in front of the door, the net being omitted here for clarity. As best shown in FIGS. 3 and 4, the door 12 is supported from hangers 13 movable in a rail 14 integrated in the top frame member 9.

A gap 15 is present between the top of the door 12 and the frame member 9 above it.

On the inside of the top frame member 9, a plate-like element 16 is depending to a level somewhat below attachments 17 between the door 12 and hangers 13. Thus, a passage 18 is formed between the door and element 16, through which all gasses leaving the container through the gap 15 have to flow. The element 16 may be attached to the frame member 9 by any suitable means, such as welding, bolts or rivets, or it may be extruded as an integral part of the frame member 9.

On the side of the depending element 16 facing the door 12, the element 16 is provided with a pocket 19 of a flame retardant vinyl coated glass fiber fabric. This pocket contains a strip of heat intumescent material 20, such as Intumex® L, with dimensions 50×2.5 millimeter. The intumescent material 20 should have swelling temperature in the range of about 130° C. to about 170° C., preferably about 140° C. to 160° C. The pocket 19 may be sewn from a strip of material or have the edges joined by cramps or the like. The pocket may even be tube knitted. The pocket is attached to the element 16 by rivets, screws or high temperature adhesive.

FIG. 3 shows the intumescent material 20 in the normal operating—or standby—condition. Should the temperature rise inside the container, e.g. caused by a smoldering fire somewhere in the cargo, hot gasses will pass through the passage 18 and out through the gap 15. This causes heating of the intumescent material 20 and causing it to swell and close the passage 18 and thereby also the container.

The container will for the most part be made of aluminum or aluminum alloy. A composite material, e.g. involving aramid fibers and resin, is also contemplated.

It will be understood that the plate-like element 16 with the pocket 19 and intumescent material 20 can be made as a separate elongate part for subsequent attachment to the top frame member 9. This means that existing containers can have their fire suppression properties improved in a simple and cost-efficient manner.

A freight container having a frame to which a bottom, a roof, and sides are attached, at least one side having a door opening closeable by a folding door made of flexible fire resistant material, the door being supported from runners moveable along a rail combined with a top member of a frame delimiting the door opening, a gap being formed between the top frame member and the top of the door in its closed condition, wherein the top member is provided with a depending support having a surface facing the inside of the door and having attached thereto a strip of heat intumescent material, a flow passage being formed between the strip and the door for gasses attempting to escape from the container through the gap, the heat intumescent material being arranged to swell and close the flow passage when subjected to hot gasses from a fire inside the container.

In an embodiment, the freight container is an air freight container.

In an embodiment, the heat intumescent material has a swelling temperature in a range of about 130° C. to about 170° C.

In an embodiment, the heat intumescent material has a swelling temperature in a range of about 140° C. to about 160° C.

In an embodiment, the nominal swelling temperature of the heat intumescent material is about 150° C.

In an embodiment, at least 50% is made from one of aluminum, aluminum alloy and a composite material, or any combination thereof.

In an embodiment, the heat intumescent material is contained in a pocked of flame resistant fabric which is fastened to the depending support.

A method of suppression of fires inside an air freight container having a flexible folding door suspended from a top frame member of the container, wherein an elongate strip of metal provided with a heat intumescent material is attached to the top frame member with the heat intumescent material facing the door.

An element for installation on a freight container having a flexible folding door suspended from a top frame member of the container for aiding in suppression of fires inside the container, wherein the element comprises an elongate strip of metal provided on one side with a pocket containing a heat intumescent material, the element being intended for attachment to the top frame member.

In an embodiment, the intumescent material has a swelling temperature in a range of about 130° C. to about 170° C.

It will also be understood that the invention is not limited to the exemplifying embodiment described above, but may be varied and modified by the skilled person within the scope of the appended claims.

What is claimed is:

1. A freight container having a frame to which a bottom, a roof, and sides are attached, at least one side having a door opening closeable by a folding door made of flexible fire resistant material, the door being supported from runners moveable along a rail combined with a top member of a frame delimiting the door opening, a gap being formed between the top frame member and the top of the door in its closed condition, wherein the top member is provided with a depending support having a surface facing the inside of the door and having attached thereto a strip of heat intumescent material, a flow passage being formed between the strip and the door for gasses attempting to escape from the container through the gap, the heat intumescent material being arranged to swell and close the flow passage when subjected to hot gasses from a fire inside the container.

2. A freight container according to claim 1, wherein the freight container is an air freight container.

3. A freight container according to claim 1, wherein the heat intumescent material has a swelling temperature in a range of about 130° C. to about 170° C.

4. A freight container according to claim 1, wherein the heat intumescent material has a swelling temperature in a range of about 140° C. to about 160° C.

5. A freight container according to claim 1, wherein the nominal swelling temperature of the heat intumescent material is about 150° C.

6. A freight container according to claim 1, wherein at least 50% is made from one of aluminum, aluminum alloy and a composite material, or any combination thereof.

7. A freight container according to claim 1, wherein the heat intumescent material is contained in a pocked of flame resistant fabric which is fastened to the depending support.

8. A method of suppression of fires inside an air freight container having a flexible folding door suspended from a top frame member of the container, wherein an elongate strip of metal provided with a heat intumescent material is attached to the top frame member with the heat intumescent material facing the door.

9. An element for installation on a freight container having a flexible folding door suspended from a top frame member of the container for aiding in suppression of fires inside the container, wherein the element comprises an elongate strip of metal provided on one side with a pocket containing a heat intumescent material, the element being intended for attachment to the top frame member.

10. An element according to claim 9, wherein the intumescent material has a swelling temperature in a range of about 130° C. to about 170° C.
